(19) United States
(12) Patent Application Publication
(10) Pub. No.: US 2018/0290217 A1
(43) Pub. Date: Oct. 11, 2018

(54) Pocket Hole Jig with Automatic Adjustment

(71) Applicant: Michael Asimakis, Scottsdale, AZ (US)

(72) Inventor: Michael Asimakis, Scottsdale, AZ (US)

(21) Appl. No.: 15/946,973

(22) Filed: Apr. 6, 2018

Related U.S. Application Data
(60) Provisional application No. 62/482,627, filed on Apr. 6, 2017.

(51) Int. Cl. B23B 47/28; F16H 19/04; F16H 51/02

(52) U.S. Cl. CPC B23B 47/28; F16H 19/04; B23B 2260/004; B23B 2247/10; F16H 51/02

(57) ABSTRACT

In an embodiment, a pocket hole jig is provided having a base, a lever, a clamp, a drill bit guide and a rack and pinion system. The rack and pinion system is configured to automatically adjust the pocket hole jig according to a position of the lever and the clamp.

### TECHNICAL FIELD

The present disclosure is related generally to a pocket hole jig device, and, more particularly, to an automatic adjusting pocket hole jig device.

### BACKGROUND

Woodworking, carpentry or similar craft often incorporates joining two or more workpieces together to form a desired structure. Pocket joining is a technique that can be used to join two work pieces together by drilling, or otherwise forming a hole at a specified angle in one workpiece and inserting a screw, or other joining device into the hole to join the two workpieces together. A jig, a guide, or other such device can be used to direct the hole formation in the workpiece. Moreover, the jig may be configured to form pocket holes in one or more of the workpieces in order to join workpieces together. However, the desired structure may include workpieces that have a different thickness, length, width, or other such dimension. Therefore, it may be helpful for the jig or other such device to automatically adjust to dimensions of each workpiece that is being joined.

While the present disclosure is directed to a device that can eliminate certain shortcomings noted in or apparent from the above, it will be appreciated that such a benefit is neither a limitation on the scope of the disclosed principles nor of the attached claims, except to the extent expressly noted in the claims. Additionally, the discussion in this Background section is reflective of the inventors' own observations, considerations, and thoughts, and is not intended to catalog or summarize any item of prior art. As such, the inventors expressly disclaim this section as admitted or assumed prior art. Moreover, the identification or implication herein of a desirable course of action reflects the inventors' own observations and ideas, and therefore cannot be assumed to indicate an art-recognized desirability.

### SUMMARY

In keeping with an embodiment of the present disclosure, a miniature pocket hole jig is disclosed. The miniature pocket hole jig may include a frame, a drill bit guide, and a rack and pinion system. The rack and pinion system may be configured to automatically adjust the miniature pocket hole jig.

In accordance with an alternative embodiment of the present disclosure, a pocket hole jig is disclosed. The pocket hole jig may include a base, a lever a clamp, a drill bit guide, and a rack and pinion system. The rack and pinion system may be configured to automatically adjust the pocket hole jig according to a position of the lever and the clamp.

Other features and aspects of embodiments of the disclosed principles will be appreciated from the detailed disclosure taken in conjunction with the included figures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an exploded perspective view of a pocket hole jig device in accordance with an embodiment of the present disclosure;

FIG. 2A is a perspective side view of the pocket hole jig device of FIG. 1 mounted on a workpiece in accordance with an embodiment of the present disclosure;

FIG. 2B is a perspective side view of the pocket hole jig device of FIG. 1 mounted on a workpiece in accordance with an embodiment of the present disclosure;

FIG. 2C is a side view of the pocket hole jig device of FIG. 1 mounted on a workpiece in accordance with an embodiment of the present disclosure;

FIG. 2D is an end view of the pocket hole jig device of FIG. 1 mounted on a workpiece in accordance with an embodiment of the present disclosure;

FIG. 2E is an end view of the pocket hole jig device of FIG. 1 mounted on a workpiece in accordance with an embodiment of the present disclosure;

FIG. 2F is a perspective bottom view of the pocket hole jig device of FIG. 1 mounted on a workpiece in accordance with an embodiment of the present disclosure;

FIG. 2G is a perspective bottom view of the pocket hole jig device of FIG. 1 mounted on a workpiece in accordance with an embodiment of the present disclosure;

FIG. 3 is an exploded perspective view of an alternative pocket hole jig device in accordance with another embodiment of the present disclosure;

FIG. 4A is a perspective side view of the pocket hole jig device of FIG. 3 in an open position, in accordance with an embodiment of the present disclosure;

FIG. 4B is a perspective side view of the pocket hole jig device of FIG. 3 in an open position, in accordance with an embodiment of the present disclosure;

FIG. 4C is a top view of the pocket hole jig device of FIG. 3 in an open position, in accordance with an embodiment of the present disclosure;

FIG. 4D is a side view of the pocket hole jig device of FIG. 3 in an open position, in accordance with an embodiment of the present disclosure;

FIG. 4E is a bottom view of the pocket hole jig device of FIG. 3 in an open position, in accordance with an embodiment of the present disclosure;

FIG. 4F is an end view of the pocket hole jig device of FIG. 3 in an open position, in accordance with an embodiment of the present disclosure;

FIG. 4G is an end view of the pocket hole jig device of FIG. 3 in an open position, in accordance with an embodiment of the present disclosure;

FIG. 4H is a perspective bottom view of the pocket hole jig device of FIG. 3 in an open position, in accordance with an embodiment of the present disclosure;

FIG. 4I is a perspective bottom view of the pocket hole jig device of FIG. 3 in an open position, in accordance with an embodiment of the present disclosure;

FIG. 5A is a perspective side view of the pocket hole jig device of FIG. 3 in a closed position, in accordance with an embodiment of the present disclosure;

FIG. 5B is a perspective side view of the pocket hole jig device of FIG. 3 in a closed position, in accordance with an embodiment of the present disclosure;

FIG. 5C is a top view of the pocket hole jig device of FIG. 3 in a closed position, in accordance with an embodiment of the present disclosure;

FIG. 5D is a side view of the pocket hole jig device of FIG. 3 in a closed position, in accordance with an embodiment of the present disclosure;

FIG. 5E is a bottom view of the pocket hole jig device of FIG. 3 in a closed position, in accordance with an embodiment of the present disclosure;

FIG. 5F is an end view of the pocket hole jig device of FIG. 3 in a closed position, in accordance with an embodiment of the present disclosure;

FIG. 5G is an end view of the pocket hole jig device of FIG. 3 in a closed position, in accordance with an embodiment of the present disclosure;

FIG. 5H is a perspective bottom view of the pocket hole jig device of FIG. 3 in a closed position, in accordance with an embodiment of the present disclosure;

FIG. 5I is a perspective bottom view of the pocket hole jig device of FIG. 3 in a closed position, in accordance with an embodiment of the present disclosure;

FIG. 6 is an enlarged side view of the pocket hole jig device of FIG. 3 in a closed position, in accordance with an embodiment of the present disclosure;

FIG. 7 is an enlarged partial transparent side view of the pocket hole jig device of FIG. 3 in an open position, in accordance with an embodiment of the present disclosure;

FIG. 8 is an enlarged side perspective view of the pocket hole jig device, in accordance with an embodiment of the present disclosure;

FIG. 9 is an enlarged side perspective view of the pocket hole jig device, in accordance with an embodiment of the present disclosure;

FIG. 10 is a perspective view of a gear of the pocket hole jig device, in accordance with an embodiment of the present disclosure;

FIG. 11 is a schematic view of a gear of the pocket hole jig device, in accordance with an embodiment of the present disclosure;

FIG. 12 is a schematic view of a gear of the pocket hole jig device, in accordance with an embodiment of the present disclosure;

FIG. 13 is a schematic view of a hand lever of the pocket hole jig device, in accordance with an embodiment of the present disclosure;

FIG. 14 is a schematic view of a drill collar of the pocket hole jig device, in accordance with an embodiment of the present disclosure; and

FIG. 15 is a schematic view of a drill block of the pocket hole jig device in accordance with an embodiment of the present disclosure.

### DETAILED DESCRIPTION

The present disclosure illustrates an automatically adjusting pocket hole jig, generally designated. The gig includes a base having a clamp end, a toggle end, opposing sides and, and a platform extending from side to side and positioned intermediate clamp end and toggle end. The base also includes a channel formed at clamp end and extending from clamp end to platform. Portions of the base at each side respectively, extend from the clamp end to the platform to define the channel and act as guide rails. A guide holder extends substantially perpendicularly upwardly from the platform. The guide holder includes an inwardly facing vertical slot, proximate to a side and an inwardly facing vertical slot, proximate to the other side, each extending upwardly from the platform. While the base preferably includes a planar bottom to allow it to be placed and used on a work surface, it will be understood that the base can have substantially any bottom to allow it to be placed on a surface or fixed to a surface such as with brackets, pegs and the like.

An embodiment of the jig also includes a guide carried by the guide holder and reciprocally movable vertically along a plurality of slots between a raised position and a lowered position. The guide includes a body having a top, a bottom and at least one and preferably two guide channels extending therethrough, from the top to a surface above the bottom. The guide channels are disposed to receive and guide the shank of a drill bit. A clamp assembly is carried within the channel of the base. The clamp assembly includes a carriage reciprocally movable within the channel, away from the guide, toward the end (rearward position) and toward guide, away from the end (forward position) and a clamp arm positioned above and carried by carriage. The clamp arm is directed towards a toggle end and terminates in a foot element. Foot element engages a work piece to hold the work piece on platform abutting surface of the guide.

The guide is also movable between the lowered position and the raised position by an adjustment mechanism contemporaneous with the movement of guide. The adjustment mechanism includes a bar extending from the toggle end under platform and into the channel. The bar fixedly engages the carriage of the clamp assembly. When the bar is pushed longitudinally toward clamp end, the clamp assembly is moved toward the rearward position. When the bar is pulled longitudinally away from the clamp end, the clamp assembly is moved toward the forward position. To make movement of the guide member contemporaneous with movement of the clamp assembly, the adjustment mechanism includes a rack and pinion system. A double set of pinions (circular gears) are employed. A set of guide pinions are carried by a pin extending transversely through the base from one side to the other side. The guide pinions are spaced apart and each positioned adjacent to one of sides. A set of clamp pinions are carried by pin and are spaced apart and each positioned inside and adjacent to one of guide pinions. Guide pinions and clamp pinions rotate together, so that either the adjacent pinions are fixed together, or they are each fixed to the pin so as to rotate together. Clamp racks and (linear gears) extend forwardly from the carriage within the channel toward the toggle end. The clamp racks are spaced apart and parallel and engage the clamp pinions. The guide racks extend downwardly from the bottom on opposing sides of the body. The racks are received down through the slots, respectively to a position below the platform to engage the guide pinions.

Therefore, as the bar moves the clamp assembly, the clamp racks rotate the clamp pinions. The rotation of the clamp pinions also results in the rotation of the guide pinions. The rotation of the guide pinions translates into linear motion of the guide racks, moving the guide contemporaneously with movement of the clamp assembly. Guide pinions and clamp pinions can have different diameters to provide a proportional change from linear motion to rotational motion and back to linear motion. In this manner, the distance of the horizontal linear movement of the clamp assembly by the bar is proportionately translated to a vertical linear movement of the guide. This translation can be fixed to a specific ratio of pinions so that as the clamp assembly is moved to a distance from the guide to accommodate a work piece having a specific thickness, the guide self-adjusts, and is raised to a height with the correct proportions relative the thickness of the workpiece for positioning a pocket hole. A 7/10 gear ratio is preferred, but it will be understood that other ratios such as 6/10, or other such ratio, can be employed to achieve the desired movement of the guide in relation to clamp assembly.

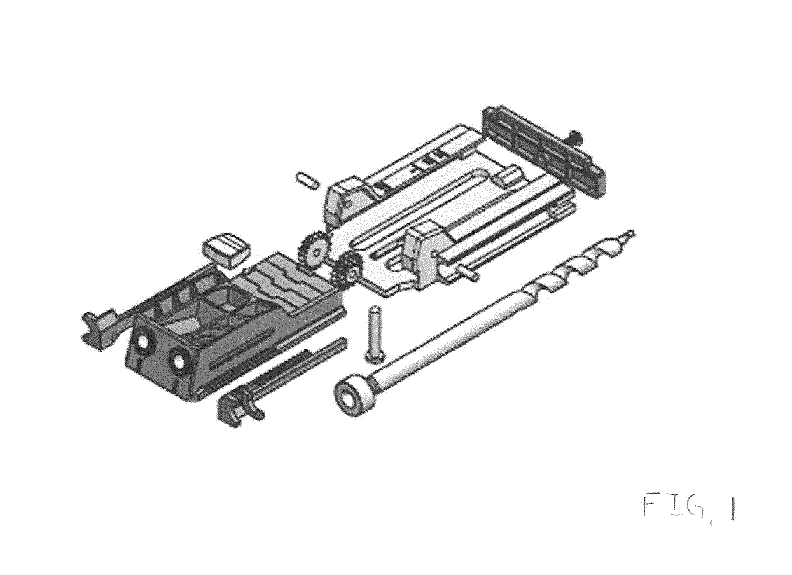

FIG. 1 illustrates an exploded perspective view of a miniature sized pocket hole jig device that is configured to automatically adjust according to the workpiece size inserted into the jig.

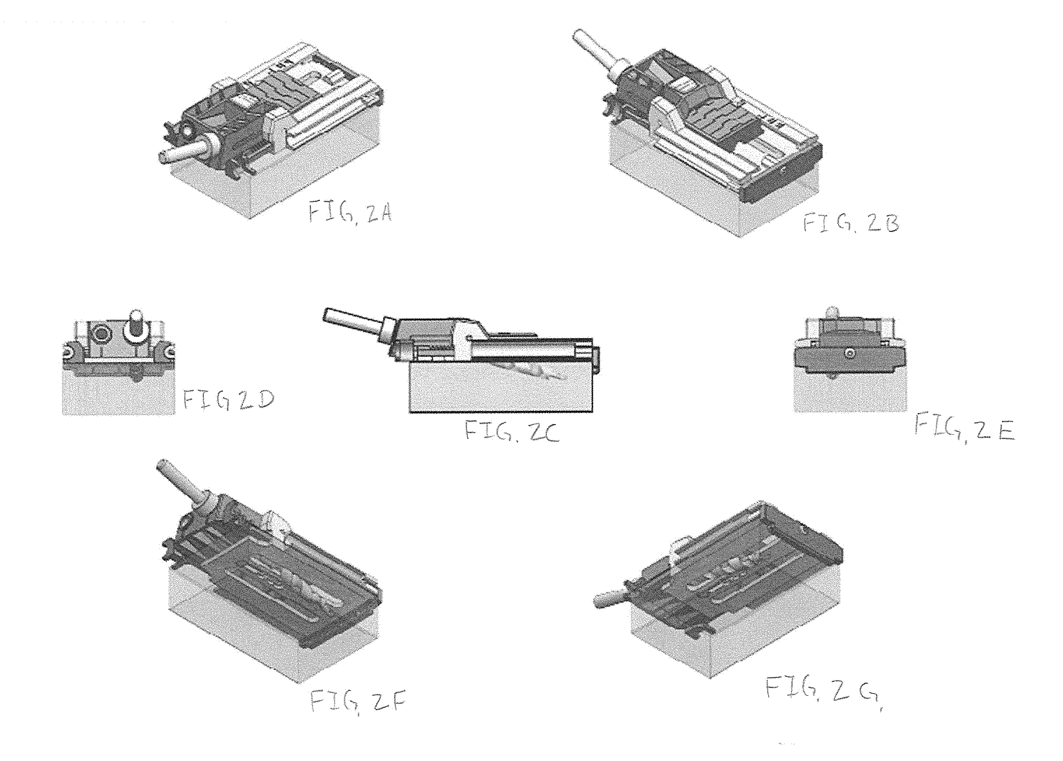

FIGS. 2A-2G show various perspective views of the miniature sized pocket hole jig mounted onto the workpiece.

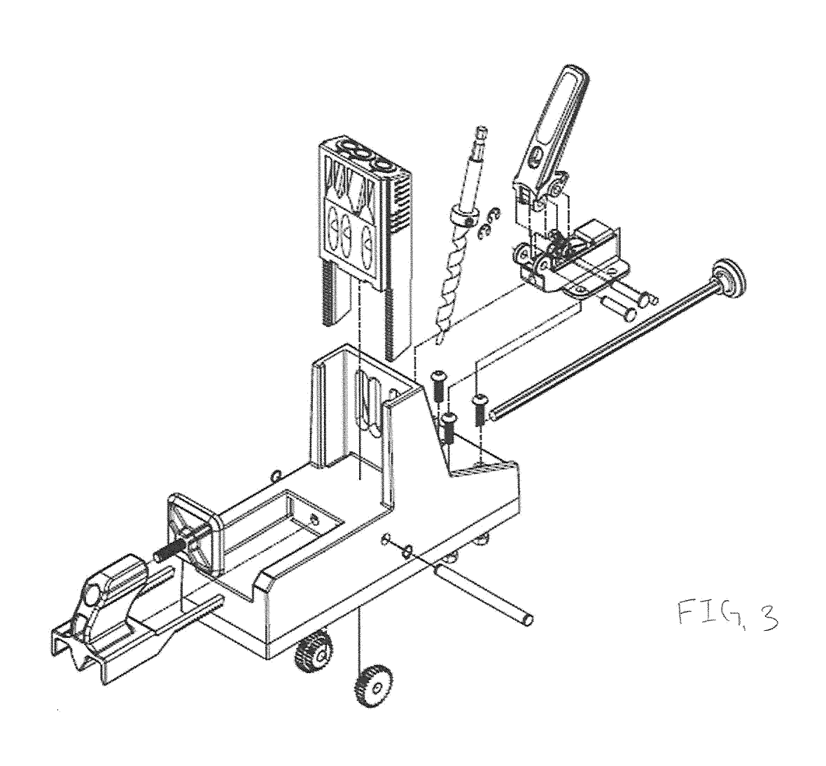

FIG. 3 illustrates an exploded perspective view of an automatically adjustable pocket hole jig device that can adjust to accept multiple sizes of the workpiece. For example, the jig may be configured to automatically adjust to a range of workpiece sizes between 0.5 inches and 1.5 inches; however, other size ranges may be possible.

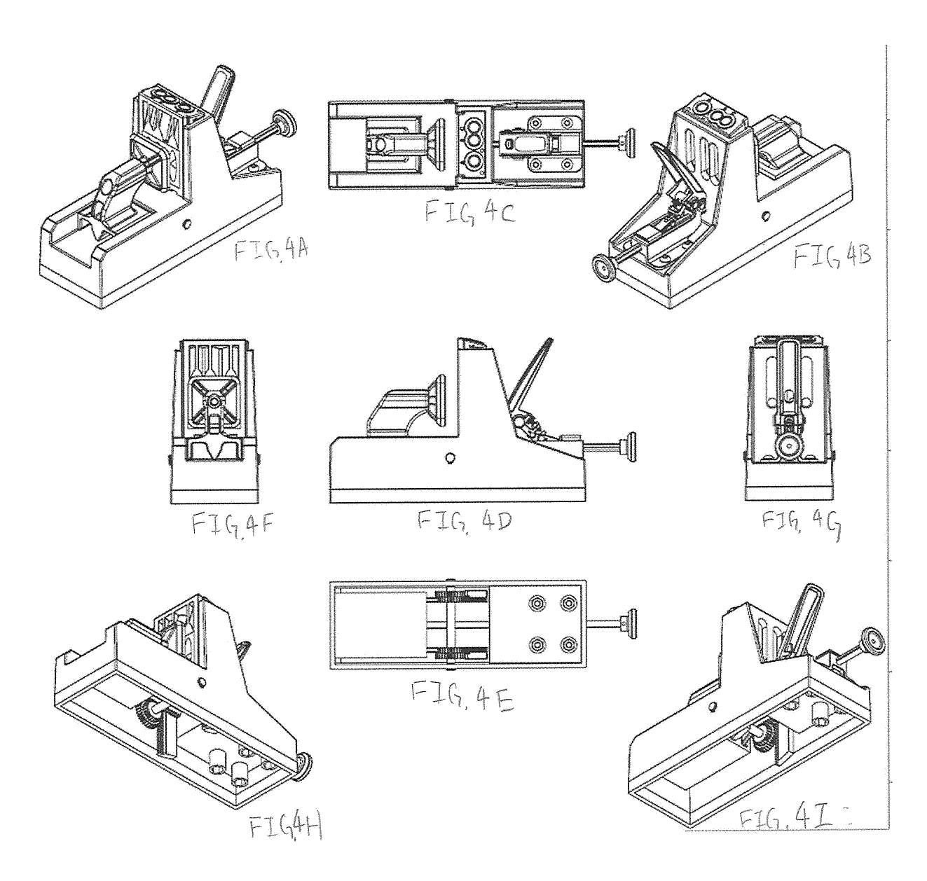

FIGS. 4A-4I show various perspective views of the pocket hole jig device open position.

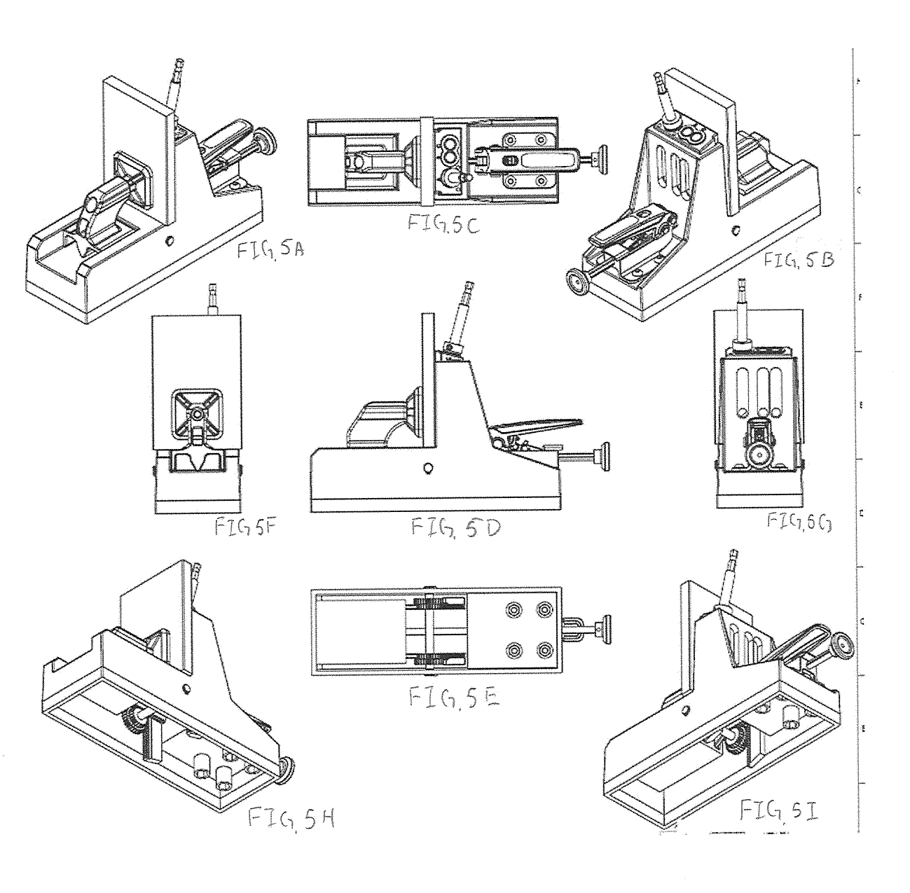

FIGS. 5A-5I show various perspective views of the pocket hole jig device in a closed position holding the workpiece.

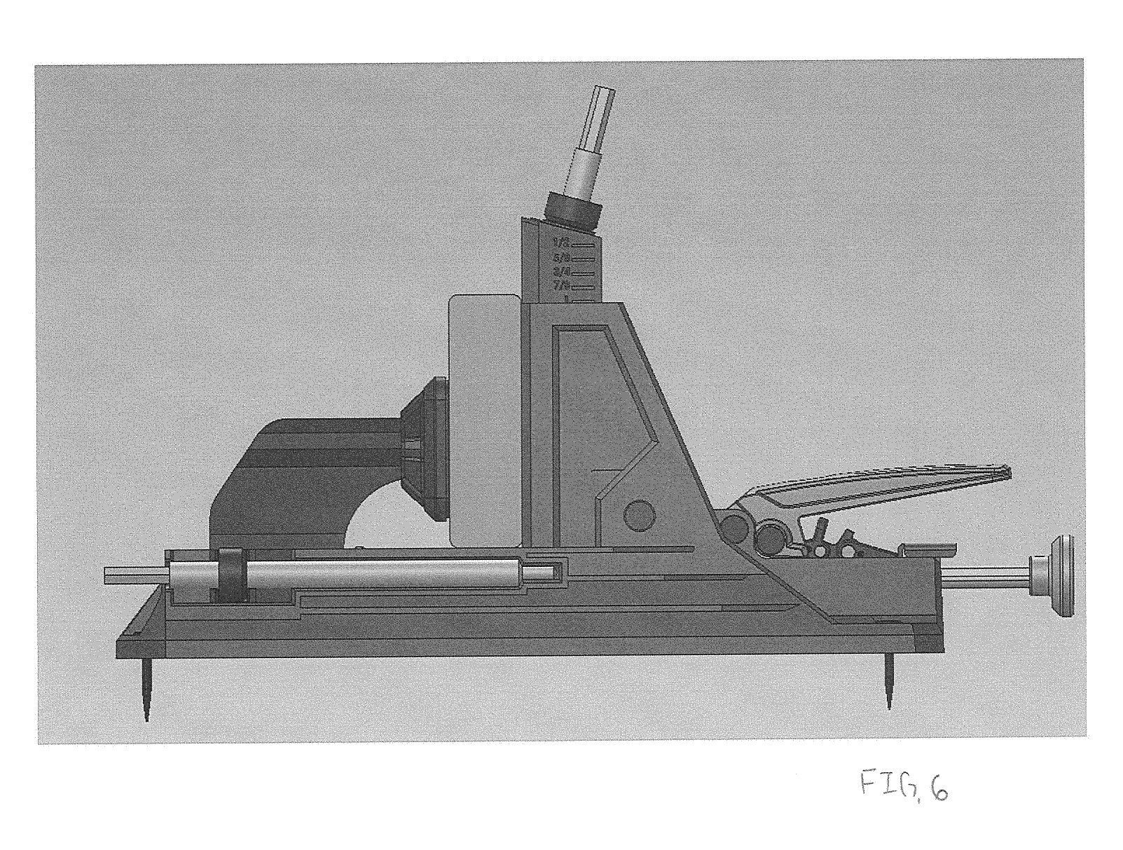

FIG. 6 is an enlarged side view of the pocket hole jig device of in a closed position.

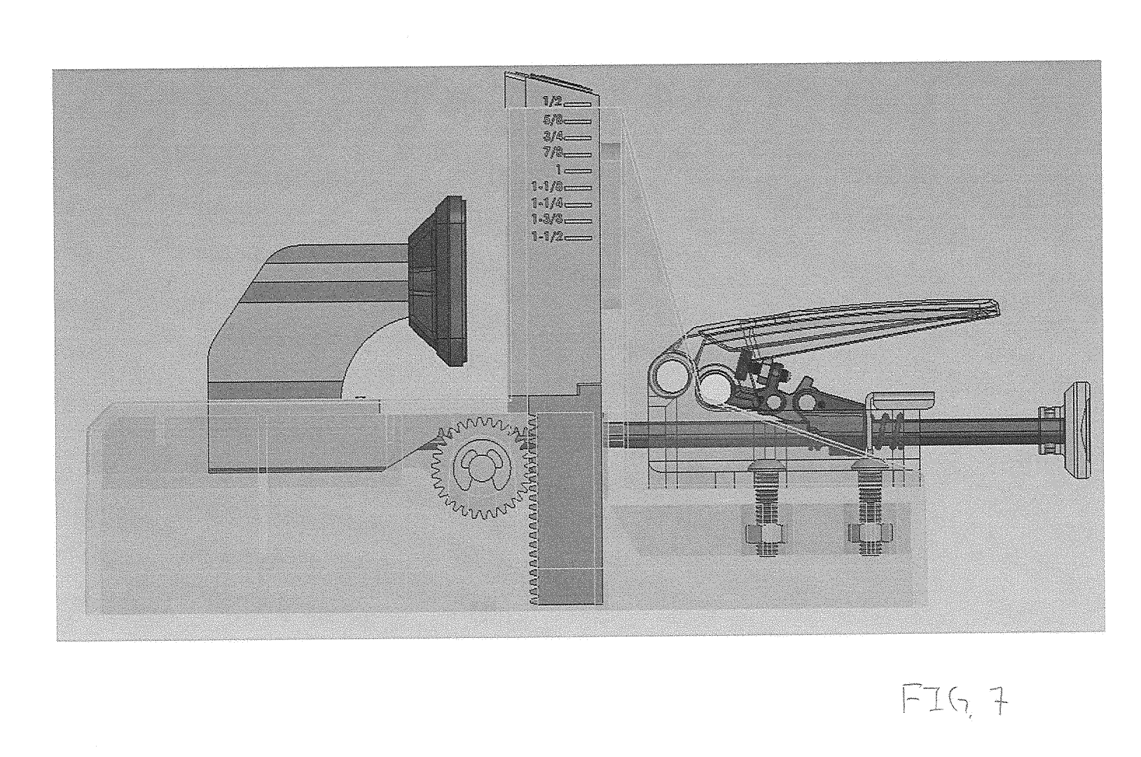

FIG. 7 is an enlarged partial transparent side view of the pocket hole jig in an open position and showing the rack and pinion.

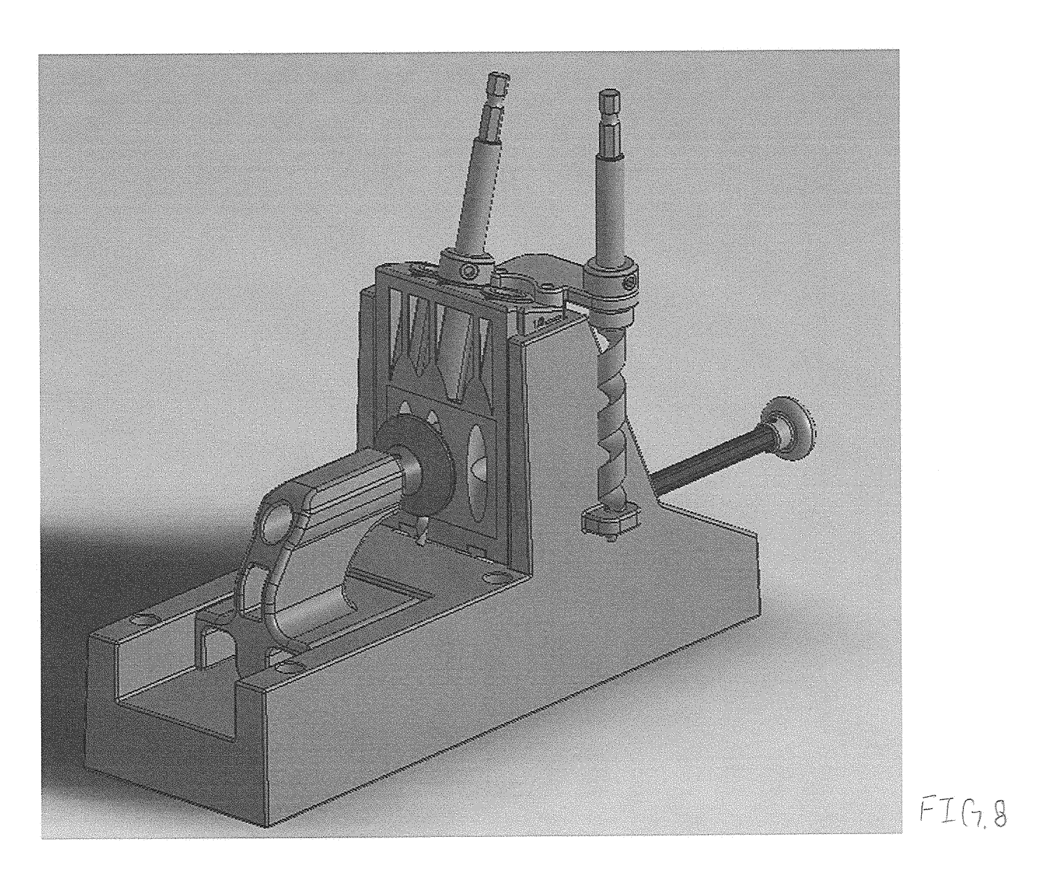

FIG. 8 is an enlarged side perspective view of the pocket hole jig device including one or more drill bits extending through the drill guide.

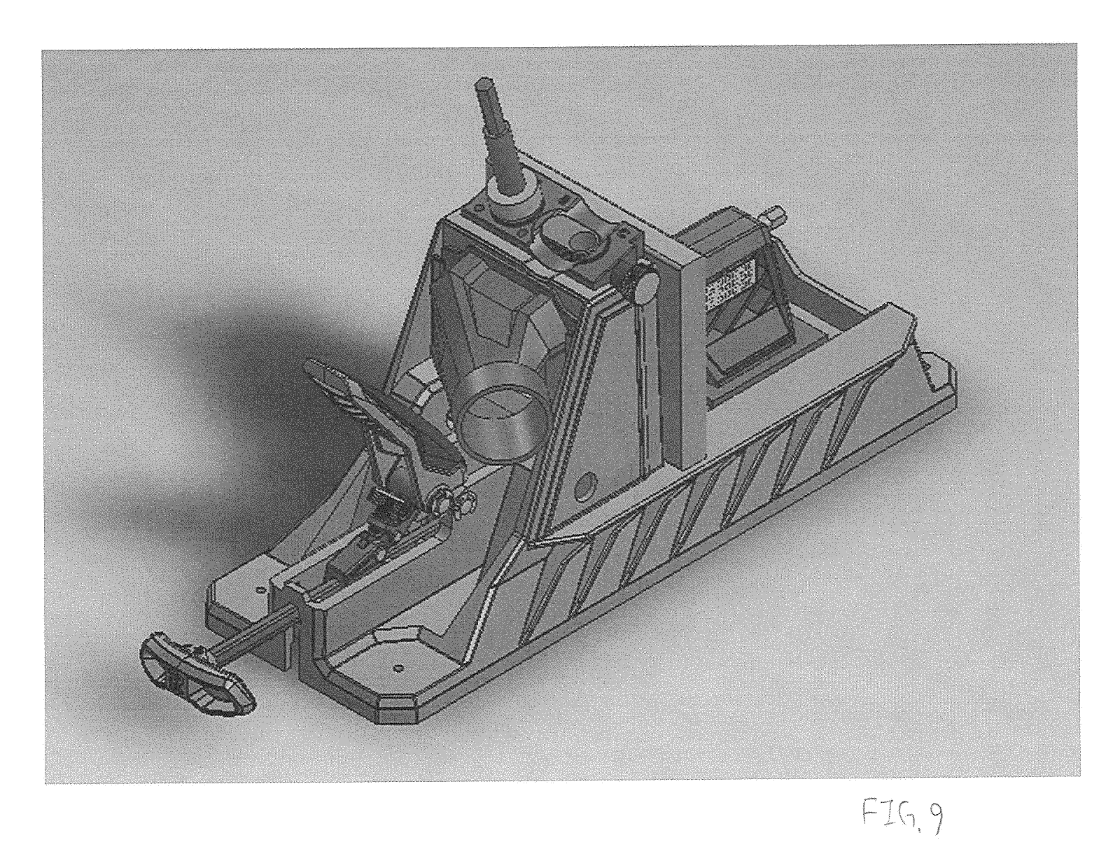

FIG. 9 is an enlarged side perspective view of the pocket hole jig device, including a vacuum attachment

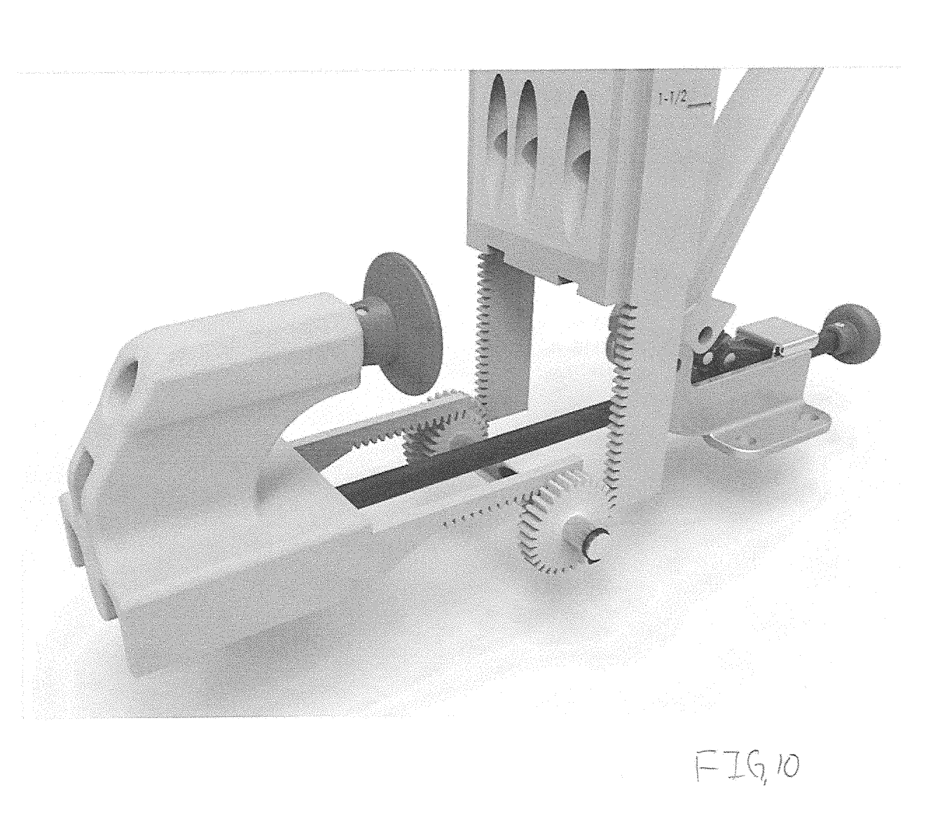

FIG. 10 is a perspective view of the rack and pinion system of the pocket hole jig device.

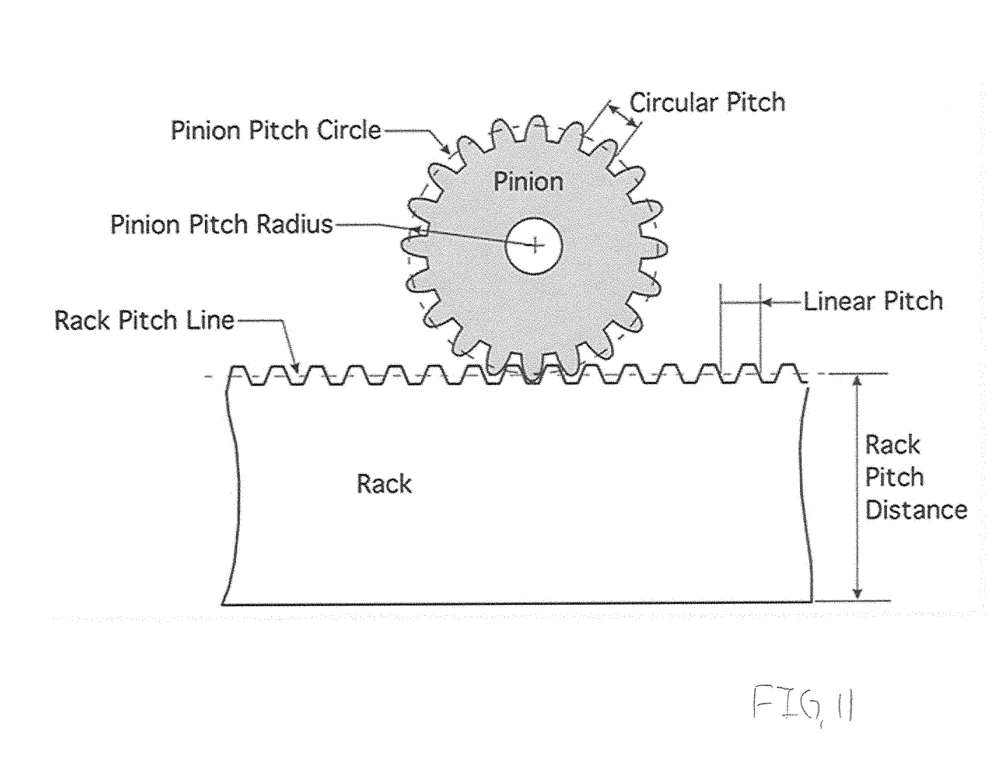

FIG. 11 is a schematic view of a gear of the pocket hole jig device.

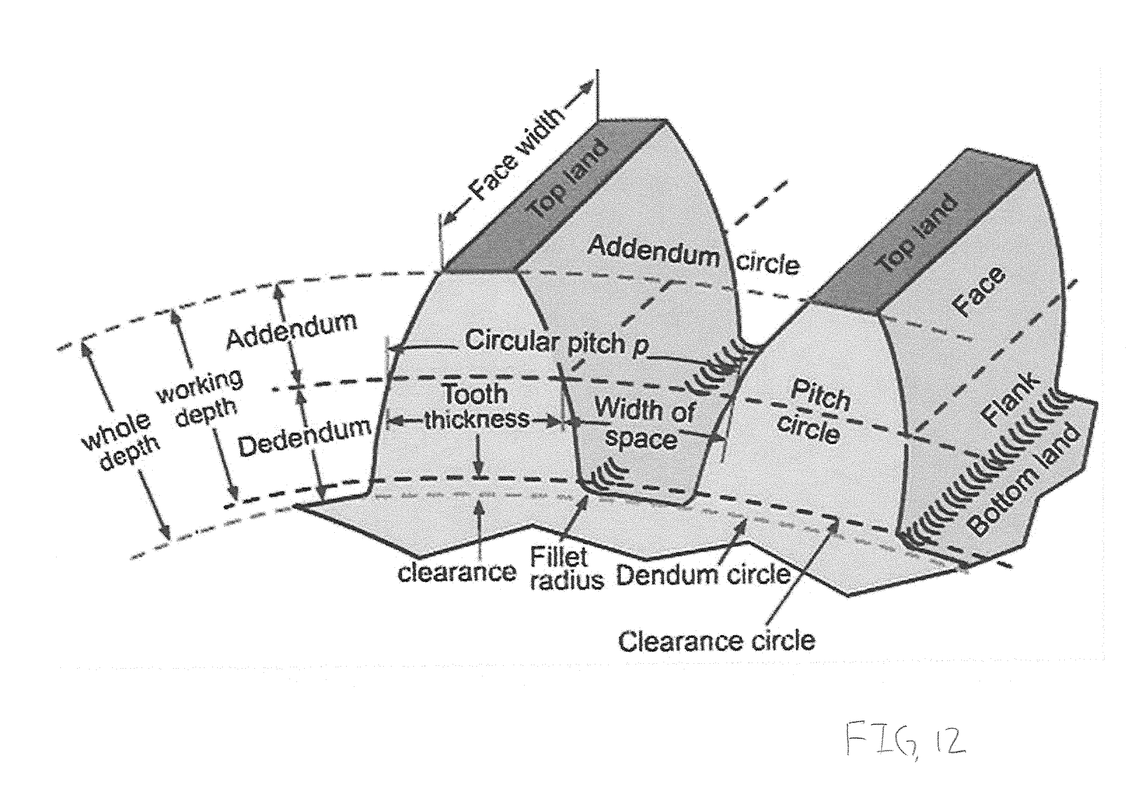

FIG. 12 is a schematic view of a gear of the pocket hole jig device.

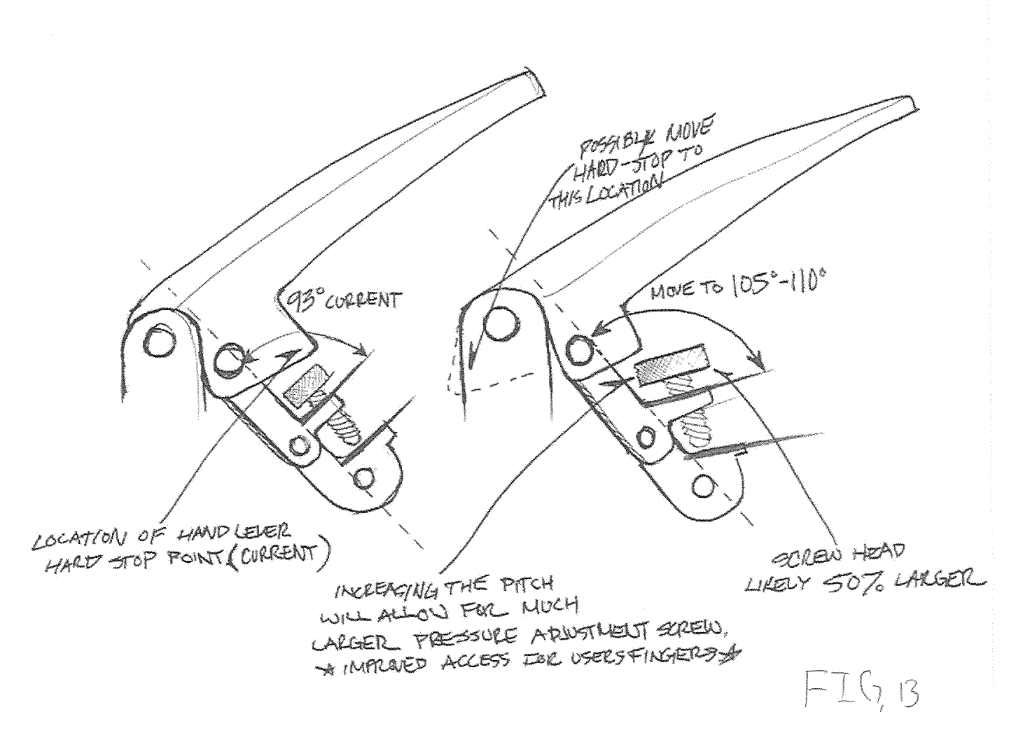

FIG. 13 is a schematic view of a hand lever illustrating different set screws used in the hand lever of the pocket hole jig device.

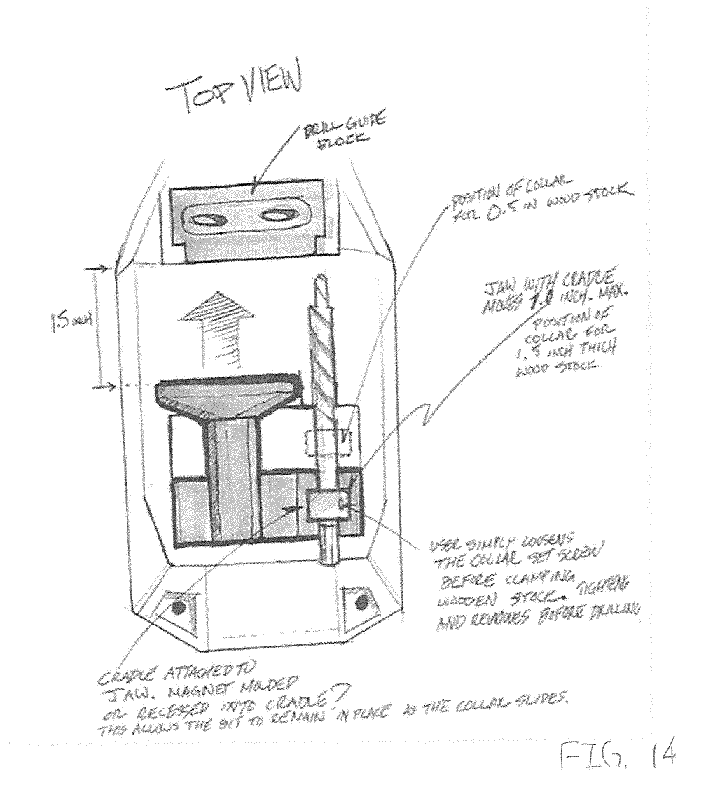

FIG. 14 is a schematic view of a drill collar of the pocket hole jig device.

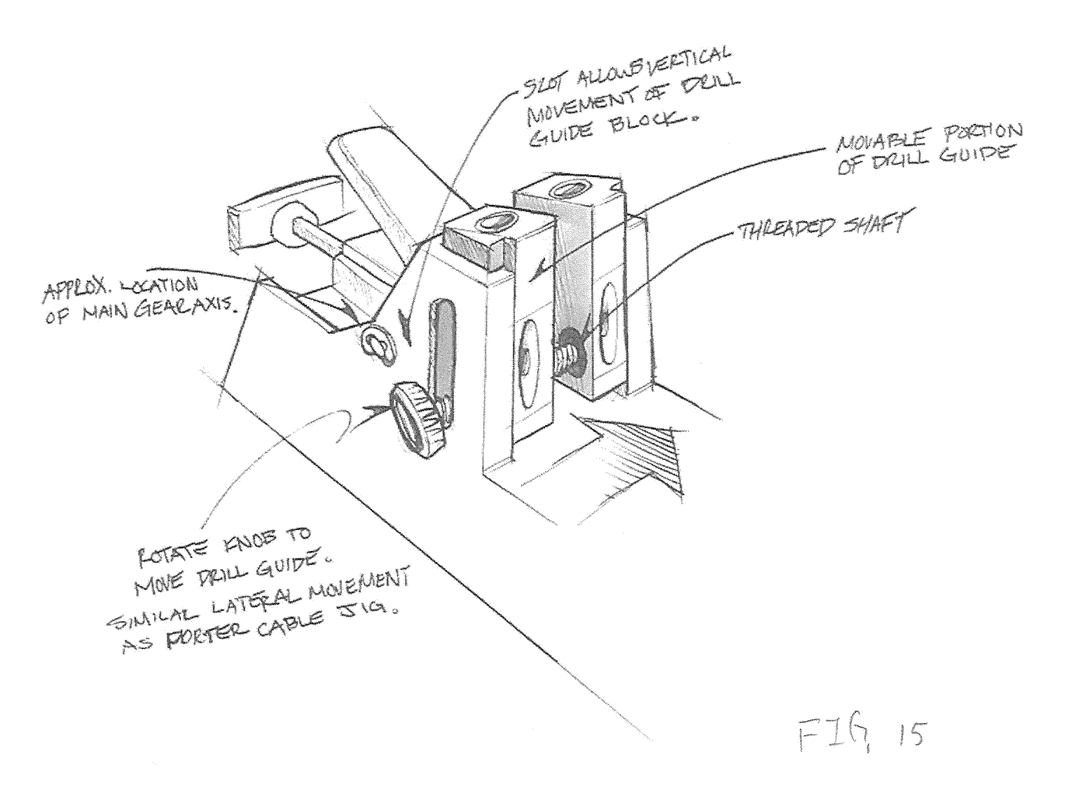

FIG. 15 is a schematic view of a drill block of the pocket hole jig device.

We claim:

1. A miniature pocket hole jig comprising:
a frame;
a drill bit guide; and
a rack and pinion system configured to automatically adjust the miniature pocket hole jig.

2. A pocket hole jig comprising:
a base;
a lever;
a clamp
a drill bit guide; and
a rack and pinion system configured to automatically adjust the pocket hole jig according to a position of the lever and the clamp.

3. A miniature pocket hole jig as shown in the figures.

4. A pocket hole jig as shown in the figures.
